(19) United States
(12) Patent Application Publication
(10) Pub. No.: US 2016/0323115 A1
(43) Pub. Date: Nov. 3, 2016

(54) Power Supply Protection System and Method for POE

(71) Applicant: ZTE CORPORATION, Shenzhen (CN)

(72) Inventors: Jiajie ZHANG, Shenzhen (CN); Xin WANG, Shenzhen (CN); Yubing TANG, Shenzhen (CN); Yonghong DU, Shenzhen (CN)

(21) Appl. No.: 15/108,447

(22) PCT Filed: Jun. 4, 2014
(86) PCT No.: PCT/CN2014/079180

§ 371 Date: Jun. 27, 2016

(30) Foreign Application Priority Data
Dec. 27, 2013 (CN) 201310739534.1

(51) Int. Cl. H04L 12/10

(52) U.S. Cl. CPC H04L 12/10

(57) ABSTRACT

A power supply protection system includes at least one of: a PSE proximal-end protection module (10), arranged at a proximal end of a PSE chip and configured to protect each pin of the PSE chip in a sudden change process of a voltage and current of a proximal-end power loop of the PSE chip; a PSE distal-end protection module (12), arranged between the proximal end of the PSE chip and a PSE network port and configured to suppress interference from a network cable and a network port and reduce a sudden change of a loop of the PSE chip into a range bearable for a proximal end of PSE; a PD distal-end protection module (14), arranged between a proximal end of a PD chip and a PD network port; and a PD proximal-end protection module (16), arranged at the proximal end of the PD chip.

### TECHNICAL FIELD

The present disclosure relates to the technical field of computers, and in particular to a power supply protection system and method for Power Over Ethernet (POE).

### BACKGROUND

POE is a standard specification for supplying power at the same time of transmitting data by virtue of an existing standard Ethernet transmission cable, and it is compatible with an existing Ethernet system and existing users. Power is input into a common mode tap of a transformer at an Ethernet signal sender end, and power energy is extracted from a common mode tap at an Ethernet signal receiver end. A series of detection and identification is involved, voltages and currents are controlled, a corresponding sender controller is called Power Supply Equipment (PSE) and a receiver controller is called a Powered Device (PD).

In 1999, the Institute of Electrical and Electronics Engineers (IEEE) started researching and developing a POE technology and formulating the first POE standard 802.3af. The IEEE formally approved standard 802.3af in June, 2003, which adds a related standard for directly supplying power through a network cable on the basis of IEEE 802.3 and is an extension of an existing Ethernet standard as well as the first international standard about power distribution. The standard 802.3af specifies PSE output power of 15.4W, defines power detection and control items in a remote system and specifies a manner for supplying power to equipment such as an Internet Protocol (IP) phone, a security system and a wireless Local Area Network (LAN) access point by a router, a switch and a concentrator through an Ethernet cable. In order to meet an increasing terminal power requirement, the IEEE approved standard 802.3at in July, 2005, on the basis of compatibility with 802.3af, which specifies PSE output power of 25.5 W.

POE can be easily interfered by an external signal, and PSE and PD chips are limited by their own performance indexes, so that POE may not implement normal power supply and even the PSE and PD chips may be damaged when external interference reaches a certain level. Therefore, common mode interference is usually suppressed and eliminated by adopting a device such as a gas discharge tube, a varistor and a Transient Voltage Suppressor (TVS) at present. Common mode interference may be converted into differential mode interference because positive and negative power paths in POE are not completely symmetric in a practical application process. Meanwhile, POE has its own specificity, such as fixed power anode and cathode switching control and current same-direction interference sensitivity, which may cause interference of an external signal to POE, thereby intensifying POE unreliability. Therefore, it is urgently needed to provide a technical solution capable of implementing reliable POE.

### SUMMARY

For the problem of unreliable power supply caused by high rate of interference of an external signal to POE in a related art, the embodiments of the present disclosure provide a power supply protection system and method for POE, so as to solve the problem.

The embodiment of the present disclosure provides a power supply protection system for POE, which may include at least one of following modules: a PSE proximal-end protection module, a PSE distal-end protection module, a PD distal-end protection module and a PD proximal-end protection module, wherein

the PSE proximal-end protection module may be arranged at a proximal end of a PSE chip and configured to protect each pin of the PSE chip in a sudden change process of a voltage and current of a proximal-end power loop of the PSE chip;

the PSE distal-end protection module may be arranged between the proximal end of the PSE chip and a PSE network port and configured to suppress interference from a network cable and a network port and reduce a sudden change of a loop of the PSE chip into a range bearable for a proximal end of PSE;

the PD distal-end protection module may be arranged between a proximal end of a PD chip and a PD network port and configured to suppress interference from a network cable and a network port and reduce a sudden change of a loop of the PD chip into a range bearable for a proximal end of a PD; and

the PD proximal-end protection module may be arranged at the proximal end of the PD chip and configured to protect each pin of the PD chip in a sudden change process of a voltage and current of the proximal-end power loop of the PD chip.

Preferably, the PSE proximal-end protection module may include: an external voltage clamping module, a network port voltage clamping module, a peak current absorption module, a reverse current suppression module and a short-circuit protection discharge module, wherein

the external voltage clamping module may be configured to clamp external input power;

the network port voltage clamping module may be configured to clamp a voltage fluctuation from the network port;

the peak current absorption module may be configured to absorb a surge current peak;

the reverse current suppression module may be configured to suppress a current fluctuation opposite to a POE current direction; and

the short-circuit protection discharge module may be configured to discharge port impact current in a POE short-circuit protection process.

Preferably, the PSE distal-end protection module may be arranged between the proximal end of the PSE chip and a PSE-end network port transformer, and may include: a first common mode and differential mode discharge module, a symmetric current sudden change suppression module, a common mode and differential mode voltage clamping module, a protection ground-to-line low-impedance discharge module and an asymmetric current sudden change suppression module, wherein

the first common mode and differential mode discharge module may be configured to discharge surge energy from the network port;

the symmetric current sudden change suppression module may be configured to suppress a common mode current sudden change of a positive electrode and negative electrode of a power line;

the common mode and differential mode voltage clamping module may be configured to clamp a proximal-end voltage of the PSE chip into a specific range;

the protection ground-to-line low-impedance discharge module may be configured to enable surge current to flow back through a shortest path in case of line-to-ground surging; and

the asymmetric current sudden change suppression module may be configured to suppress a current sudden change of a negative electrode of a power supply at the proximal end of the PSE chip.

Preferably, the PD distal-end protection module may be arranged between the proximal end of the PD chip and a PD-end network port transformer, and may include: a second common mode and differential mode discharge module, a reverse current suppression module and a current sudden change suppression module, wherein

the second common mode and differential mode discharge module may be configured to discharge a large amount of surge energy from the network port;

the reverse current suppression module may be configured to suppress current opposite to the POE current direction; and

the current sudden change suppression module may be configured to suppress a current sudden change on a PD current side.

Preferably, the PD proximal-end protection module may include: a first voltage clamping module and a second voltage clamping module, wherein

the first voltage clamping module may be configured to clamp a voltage sudden change of a distal end of the PD chip; and

the second voltage clamping module may be configured to clamp a voltage fluctuation of a load end.

Preferably, the system may further include:

a booster module, arranged between the external input power and the proximal end of the PSE chip and configured to boost a voltage of a circuit.

The embodiment of the present disclosure further provides a power supply protection method for POE, which may include that: a PSE proximal-end protection module receives power input by a PSE chip, protects each pin of the PSE chip in a sudden change process of a voltage and current of a proximal-end power loop of the PSE chip, and inputs the power to a PSE distal-end protection module;

the PSE distal-end protection module receives the input power, suppresses interference from a network cable and a network port, reduces a sudden change of a loop of the PSE chip into a range bearable for a proximal end of PSE, and inputs the power to a PD distal-end protection module;

the PD distal-end protection module receives the input power, suppresses interference from a network cable and a network port, reduces a sudden change of a loop of a PD chip into a range bearable for a proximal end of a PD, and inputs the power to a PD proximal-end protection module; and

the PD proximal-end protection module receives the input power, protects each pin of the PD chip in a sudden change process of a voltage and current of the proximal-end power loop of the PD chip, and provides the power for a load.

Preferably, the step that the PSE proximal-end protection module protects each pin of the PSE chip in the sudden change process of the voltage and current of the proximal-end power loop of the PSE chip may include that:

the external input power is clamped through an external voltage clamping module;

a voltage fluctuation from the network port is clamped through a network port voltage clamping module;

a surge current peak is absorbed through a peak current absorption module;

a current fluctuation opposite to a POE current direction is suppressed through a reverse current suppression module; and

port impact current is discharged through a short-circuit protection discharge module in a POE short-circuit protection process.

Preferably, the step that the PSE distal-end protection module suppresses the interference from a network cable and a network port and reduces the sudden change of a loop of the PSE chip into the range bearable for the proximal end of the PSE may include that:

surge energy from the network port is discharged through a first common mode and differential mode discharge module;

a common mode current sudden change of a positive electrode and negative electrode of a power line is suppressed through a symmetric current sudden change suppression module;

a proximal-end voltage of the PSE chip is clamped into a specific range through a common mode and differential mode voltage clamping module;

surge current is enabled to flow back through a shortest path through a protection ground-to-line low-impedance discharge module in case of line-to-ground surging; and

a current sudden change of a negative electrode of a power supply at the proximal end of the PSE chip is suppressed through an asymmetric current sudden change suppression module.

Preferably, the step that the PD distal-end protection module suppresses the interference from a network cable and a network port and reduces the sudden change of the loop of the PD chip into the range bearable for the proximal end of the PD may include that:

a large amount of surge energy from the network port is discharged through a second common mode and differential mode discharge module;

current opposite to the POE current direction is suppressed through a reverse current suppression module; and

a current sudden change on a PD current side is suppressed through a current sudden change suppression module.

Preferably, the step that the PD proximal-end protection module protects each pin of the PD chip in the sudden change process of the voltage and current of the proximal-end power loop of the PD chip may include that:

a voltage sudden change of a distal end of the PD chip is clamped through a first voltage clamping module; and

a voltage fluctuation of a load end is clamped through a second voltage clamping module.

Preferably, the method may further include that:

a booster module arranged between the external input power and the proximal end of the PSE chip boosts the external input power, and transmits the boosted power to the PSE chip.

The embodiment of the present disclosure has beneficial effects as follows:

reliability design modes of the distal ends of the chips and the proximal ends of the chips are protected level by level, so that the problem of low POE transmission reliability in the related art is solved, the sudden change of the voltage and current of the power loops may be effectively suppressed, key pins of the chips may be ensured to meet a chip design requirement, and the chips may be ensured to work in a normal state.

The above is only the summary of the technical solutions of the embodiment of the present disclosure, and in order to more clearly understand and implement the technical means of the present disclosure according to contents of the specification and make the abovementioned and other purposes, characteristics and advantages of the present disclosure more obvious and easier to understand, specific implementation modes of the present disclosure will be listed below.

### BRIEF DESCRIPTION OF THE DRAWINGS

By reading the following detailed descriptions about preferred implementation modes, those skilled in the art clearly know various other advantages and benefits. The drawings are only adopted to describe purposes of the preferred implementation modes and not intended to limit the present disclosure. Moreover, in the whole drawings, the same reference symbols are adopted to represent the same parts. In the drawings:

FIG. 1 is a structure diagram of a power supply protection system for POE according to an embodiment of the present disclosure;

FIG. 2 is a preferred structure diagram of a power supply protection system for POE according to an embodiment of the present disclosure;

FIG. 3 is a diagram of PSE proximal-end protection according to an embodiment of the present disclosure;

FIG. 4 is a diagram of an example of a part of modules of PSE proximal-end protection according to an embodiment of the present disclosure;

FIG. 5 is a diagram of PSE distal-end protection according to an embodiment of the present disclosure;

FIG. 6 is a diagram of an example of a PSE distal-end protection module according to an embodiment of the present disclosure;

FIG. 7 is a diagram of PD distal-end protection according to an embodiment of the present disclosure;

FIG. 8 is a diagram of PD proximal-end protection according to an embodiment of the present disclosure;

FIG. 9 is a diagram of boosting of external input power according to an embodiment of the present disclosure; and

FIG. 10 is a flowchart of a power supply protection method for POE according to an embodiment of the present disclosure.

### DETAILED DESCRIPTION OF THE EMBODIMENTS

Exemplary embodiments of the present disclosure will be described below with reference to the drawings in more detail. Although the exemplary embodiments of the present disclosure are shown in the drawings, it should be understood that the present disclosure may be implemented in various forms but may not be limited by the embodiments elaborated herein. Instead, these embodiments are provided to make the present disclosure understood more thoroughly and completely transmit the scope of the present disclosure to those skilled in the art.

In order to solve the problem of low POE transmission reliability in the related art, the present disclosure provides a power supply protection system and method for POE, which may ensure normal transmission of an Ethernet service and simultaneously improve POE reliability and specifically include: protection at a distal end of a PSE chip, which suppresses a sudden change of a voltage and current of a distal-end power loop of the PSE chip and reduces the sudden change into a range bearable for a proximal end of the PSE; protection at the proximal end of the PSE chip, which suppresses a sudden change of a voltage and current of a proximal-end power loop of the PSE chip and ensures that each index of each key pin of the PSE chip meets a chip design requirement in a sudden change process; protection at a distal end of a PD chip, which suppresses a sudden change of a voltage and current of a distal-end power loop of the PD chip and reduces the sudden change into a range bearable for a proximal end of the PD; and protection at the proximal end of the PD chip, which suppresses a sudden change of a voltage and current of a proximal-end power loop of the PD chip and ensures that each index of each key pin of the PD chip meets a chip design requirement in a sudden change process. The present disclosure will be further described below with reference to the drawings and embodiments in detail. It should be understood that the specific embodiments described here are only adopted to explain the present disclosure and not intended to limit the present disclosure.

System Embodiment

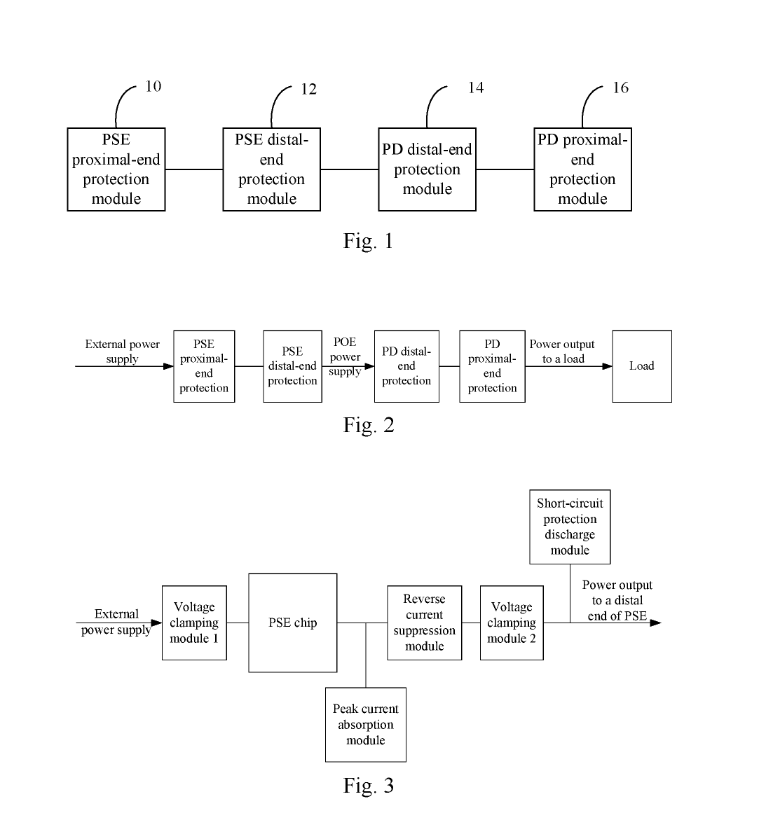

According to the embodiment of the present disclosure, a power supply protection system for POE is provided. FIG. 1 is a structure diagram of a power supply protection system for POE according to an embodiment of the present disclosure, and as shown in FIG. 1, the power supply protection system for POE according to the embodiment of the present disclosure includes at least one of following modules: a PSE proximal-end protection module 10, a PSE distal-end protection module 12, a PD distal-end protection module 14 and a PD proximal-end protection module 16. Each module of the embodiment of the present disclosure will be described below in detail.

The PSE proximal-end protection module 10 is arranged at a proximal end of a PSE chip and configured to protect each pin of the PSE chip in a sudden change process of a voltage and current of a proximal-end power loop of the PSE chip.

The PSE proximal-end protection module 10 includes: an external voltage clamping module, a network port voltage clamping module, a peak current absorption module, a reverse current suppression module and a short-circuit protection discharge module, wherein

the external voltage clamping module is configured to clamp external input power;

the network port voltage clamping module is configured to clamp a voltage fluctuation from a network port;

the peak current absorption module is configured to absorb a surge current peak;

the reverse current suppression module is configured to suppress a current fluctuation opposite to a POE current direction; and

the short-circuit protection discharge module is configured to discharge port impact current in a POE short-circuit protection process.

The PSE distal-end protection module 12 is arranged between the proximal end of the PSE chip and the PSE network port and configured to suppress interference from a network cable and a network port and reduce a sudden change of a loop of the PSE chip into a range bearable for the proximal end of the PSE.

The PSE distal-end protection module 12 is arranged between the proximal end of the PSE chip and a PSE-end network port transformer, and includes: a first common mode and differential mode discharge module, a symmetric current sudden change suppression module, a common mode and differential mode voltage clamping module, a protection ground-to-line low-impedance discharge module and an asymmetric current sudden change suppression module, wherein

the first common mode and differential mode discharge module is configured to discharge surge energy from the network port;

the symmetric current sudden change suppression module is configured to suppress a common mode current sudden change of a positive electrode and negative electrode of a power line;

the common mode and differential mode voltage clamping module is configured to clamp a proximal-end voltage of the PSE chip into a specific range;

the protection ground-to-line low-impedance discharge module is configured to enable surge current to flow back through a shortest path in case of line-to-ground surging; and

the asymmetric current sudden change suppression module is configured to suppress a current sudden change of a negative electrode of a power supply at the proximal end of the PSE chip.

The PD distal-end protection module 14 is arranged between a proximal end of a PD chip and a PD network port and configured to suppress interference from a network cable and a network port and reduce a sudden change of a loop of the PD chip into a range bearable for the proximal end of the PD.

The PD distal-end protection module 14 is arranged between the proximal end of the PD chip and a PD-end network port transformer, and includes: a second common mode and differential mode discharge module, a reverse current suppression module and a current sudden change suppression module, wherein

the second common mode and differential mode discharge module is configured to discharge a large amount of surge energy from the network port;

the reverse current suppression module is configured to suppress current opposite to the POE current direction; and

the current sudden change suppression module is configured to suppress a current sudden change on a PD current side.

The PD proximal-end protection module 16 is arranged at the proximal end of the PD chip and configured to protect each pin of the PD chip in a sudden change process of a voltage and current of the proximal-end power loop of the PD chip.

The PD proximal-end protection module 16 includes: a first voltage clamping module and a second voltage clamping module, wherein

the first voltage clamping module is configured to clamp a voltage sudden change of a distal end of the PD chip; and

the second voltage clamping module is configured to clamp a voltage fluctuation of a load end.

Preferably, according to the technical solution of the embodiment of the present disclosure, the system may further include: a booster module, arranged between the external input power and the proximal end of the PSE chip and configured to boost a voltage of a circuit.

The abovementioned technical solution of the embodiment of the present disclosure will be described below with reference to the drawings in detail.

FIG. 2 is a preferred structure diagram of a power supply protection system for POE according to an embodiment of the present disclosure. As shown in FIG. 2, the external input power is input to PSE proximal-end protection, and is input to PSE distal-end protection through PSE proximal-end protection. By POE, the power reaches PD distal-end protection, is input to PD proximal-end protection through PD distal-end protection, and is finally provided for a load. PSE proximal-end protection (the PSE proximal-end protection module 10), PSE distal-end protection (the PSE distal-end protection module 12), PD distal-end protection (the PD distal-end protection module 14) and PD proximal-end protection (the PD proximal-end protection module 16) are described below in detail respectively.

1: PSE Proximal-end Protection

Specifically, the PSE chip plays key roles in detecting whether a PD is legal or not, correctly grading a legal PD, supplying power to a successfully graded PD, monitoring a power supply voltage and current of PSE, timely protecting overcurrent short-circuit of the PSE and the like, and each pin with limited reliability is a key protection object. A circuit design of the PSE proximal-end protection module 10 is applied to the proximal end of the PSE chip, protects a sudden change of the input power or a voltage and current sudden change from a network cable and a network port of the PSE-end, and namely ensures that each index meets a chip design requirement in the sudden change process of the voltage and current of the proximal-end power loop of the PSE chip and ensures that the PSE chip is in a normal working state. By the circuit, the key pins of the PSE chip may be ensured.

The proximal end of the PSE consists of the PSE chip and the PSE proximal-end protection module 10 (protection over the key pins of the PSE chip). The power is input to the PSE chip, and the PSE chip outputs the power to a distal-end circuit of the PSE after the PSE chip finishes detection and grading of the legal PD. The PSE proximal-end protection module 10 (protection over the key pins of the PSE chip) may ensure each index of the key pins of the PSE chip meets the chip design requirement in the sudden change process of the voltage and current of the power loop and ensure stable working of the PSE chip.

FIG. 3 is a diagram of PSE proximal-end protection according to an embodiment of the present disclosure, and as shown in FIG. 3, the PSE proximal-end protection module 10 includes: the voltage clamping module 1, the voltage clamping module 2, the peak current absorption module, the reverse current suppression module and the short-circuit protection discharge module, wherein the voltage clamping module 1 is configured to clamp the external input power to ensure that the external input power is within an allowed range; the voltage clamping module 2 is configured to clamp the voltage fluctuation from the network port; the peak current absorption module is configured to absorb the surge current peak to prevent POE is stopped by misoperation of the PSE chip in a surging process; the reverse current suppression module is configured to suppress the current fluctuation opposite to the POE current direction; and the short-circuit protection discharge module ensures effective discharge of the port impact current in the POE short-circuit protection process.

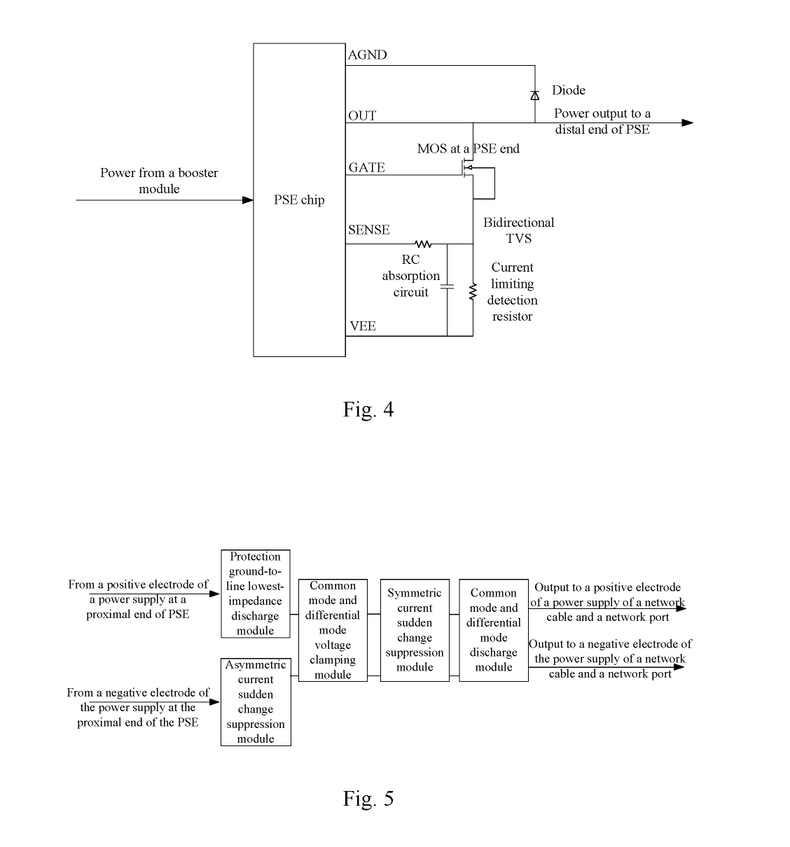

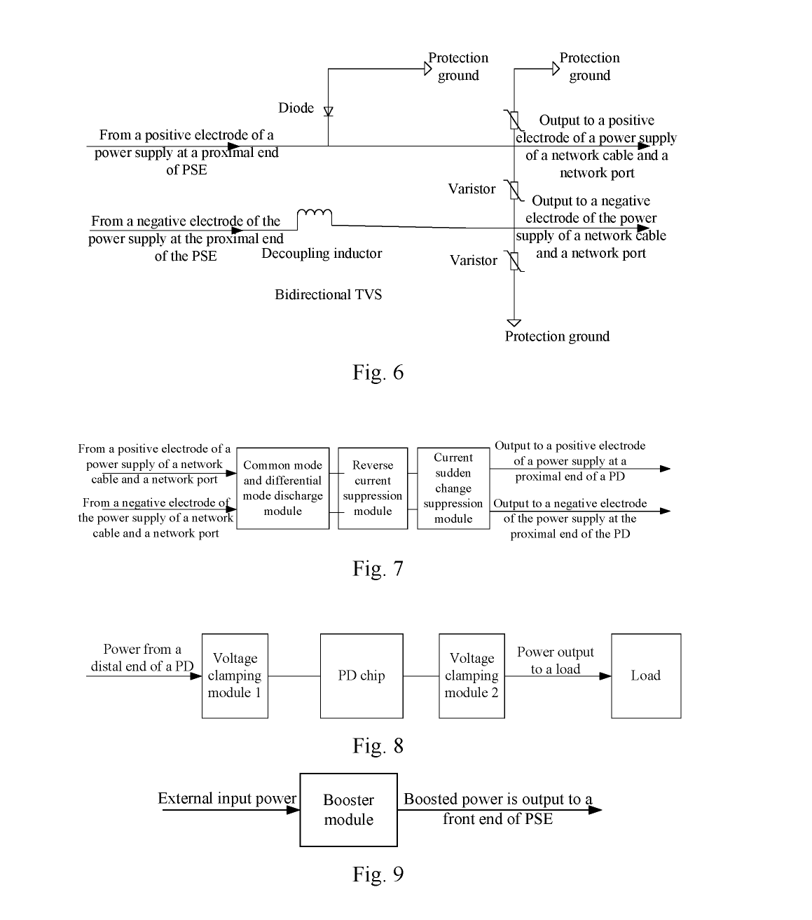

FIG. 4 is a diagram of an example of a part of modules of PSE proximal-end protection according to an embodiment of the present disclosure, and as shown in FIG. 4, the example includes the peak current absorption module and the short-circuit protection discharge module, wherein, in FIG. 6, TVS is an abbreviation of transient voltage suppressor, Metal Oxide Semiconductor (MOS) is an abbreviation of a Metal Oxide Semiconductor Field-Effect Transistor (MOSFET), AGND is an abbreviation of analogue ground, OUT is an abbreviation of an output end, GATE is an abbreviation of gate G in the MOS, SENSE is an abbreviation of a measurement circuit, and VEE is an abbreviation is a positive electrode of a power supply.

2: PSE Distal-end Protection

Specifically, strong energy interference may be introduced by a network cable and a network port of the PSE-end, such as the sudden change of the voltage and current of the distal end of the PSE in a surge and impact current test, thereby threatening normal working of the PSE chip. Therefore, it is necessary to effectively suppress and discharge the interference energy. A circuit design of the PSE distal-end protection module 12 is applied between the proximal end of the PSE and a transformer and configured to suppress the interference from a network cable and a network port to ensure that the sudden change of the loop is reduced into the range bearable for the proximal end of the PSE.

The distal end of the PSE consists of the PSE distal-end protection module 12 (PSE output network port protection) and the PSE-end network port transformer. The power input from the PSE chip to the PSE distal-end protection module 12 (PSE output network port protection) is output to the network port transformer through the PSE distal-end protection module 12. The PSE distal-end protection module 12 (PSE output network port protection) may effectively suppress the sudden change of the voltage and current of the power loop introduced by a network cable and a network port and ensure that the sudden change of the voltage and the current is reduced into the range bearable for the proximal end of the PSE.

FIG. 5 is a diagram of PSE distal-end protection according to an embodiment of the present disclosure, and as shown in FIG. 5, the PSE distal-end protection module 12 includes: the common mode and differential mode discharge module, the symmetric current sudden change suppression module, the common mode and differential mode voltage clamping module, the protection ground-to-line low-impedance discharge module and the asymmetric current sudden change suppression module, wherein the common mode and differential mode discharge module is configured to discharge most of the surge energy from the network port; the symmetric current sudden change suppression module is configured to suppress the common mode current sudden change of the positive electrode and negative electrode of the power line; the common mode and differential mode voltage clamping module clamps the proximal-end voltage of the PSE chip into the specific range; the protection ground-to-line low-impedance discharge module is configured to enable the surge current to flow back through the shortest path in case of line-to-ground surging to prevent interference to a main power loop of the PSE chip; POE is asymmetric, and is namely sensitive to interference in the POE current direction, the asymmetric current sudden change suppression module suppresses the current sudden change of the negative electrode of the power supply at the proximal end of the PSE chip.

FIG. 6 is a diagram of an example of a part of modules of PSE distal-end protection according to an embodiment of the present disclosure, and as shown in FIG. 6, the example includes the asymmetric current sudden change suppression module, the protection ground-to-line low-impedance discharge module and the common mode and differential mode discharge module.

3: PD Distal-end Protection

Specifically, strong energy interference may be introduced by a network cable and a network port of the PD-end, such as the sudden change of the voltage and current of the distal end of the PD in a surge and impact current test, thereby threatening normal working of the PSE chip. Therefore, it is necessary to effectively suppress and discharge the interference energy. A circuit design of the PD distal-end protection module 14 is applied between the proximal end of the PD and a transformer and configured to suppress the interference from a network cable and a network port to ensure that the sudden change of the loop is reduced into the range bearable for the proximal end of the PSE.

The distal end of the PD consists of the PD distal-end protection module 14 (PD output network port protection) and the PD-end network port transformer. The power from a network cable and a network port is input to the distal end of the PD, and is output to the proximal end of the PD through the PD distal-end protection module 14 (PD output network port protection). The PD distal-end protection module 14 (PD output network port protection) may effectively suppress the sudden change of the voltage and current of the power loop introduced by a network cable and a network port and ensure that the sudden change of the voltage and the current is reduced into the range bearable for the proximal end of the PD.

FIG. 7 is a diagram of PD distal-end protection according to an embodiment of the present disclosure, and as shown in FIG. 7, the PD distal-end protection module 14 includes: the common mode and differential mode discharge module, the reverse current suppression module and the current sudden change suppression module. The common mode and differential mode discharge module is configured to discharge a large amount of surge energy from the network port. The reverse current suppression module is configured to suppress current opposite to the POE current direction. The current sudden change suppression module prevents POE from being stopped by misoperation of the PD due to the current sudden change on the PD current side.

4: Protection Over the Key Pins of the PSE Chip

Specifically, the PD chip plays important roles in indicating that it is legal, normally handshaking with the PSE, monitoring a powered voltage and current of the pd, timely protecting overcurrent short-circuit of the PD and the like, and each pin with limited reliability needs key protection. A circuit design of the PD proximal-end protection module 16 is applied to the proximal end of the PD chip, protects a voltage and current sudden change introduced from a network cable and a network port of the PD or a next-stage load sudden change, and namely ensures that each index meets a chip design requirement in the sudden change process of the voltage and current of the proximal-end power loop of the PD chip and ensures that the PD chip is in a normal working state. The proximal end of the PD consists of the PD chip and the PD proximal-end protection module 16 (protection over the key pins of the PD chip). Power from the distal end of the PD is input to the proximal end of the PD, and the PD chip provides the power for the load. The PD proximal-end protection module 16 (protection over the key pins of the PD chip) may ensure that each index of the key pins of the PD chip meets the chip design requirement in the sudden change process of the voltage and current of the power loop and ensure stable working of the PD chip.

FIG. 8 is a diagram of PD proximal-end protection according to an embodiment of the present disclosure, and as shown in FIG. 8, the voltage clamping module 1 and the voltage clamping module 2 are specifically included. The voltage clamping module 1 is configured to clamp the voltage sudden change from the distal end of the PD. The voltage clamping module 2 is configured to clamp the voltage fluctuation from the load end.

5: Booster Module

Since impedance of a device such as a network cable, a transformer and a crystal head is constant, increasing transmission voltage and reducing transmission current under the condition that total POE transmission power is determined may effectively reduce loss on a transmission path, and an efficient POE transmission solution is further provided. The circuit design of this part is applied between the external input power and the proximal end of the PSE, and after the external power passes through the booster module, the boosted power is input to the proximal end of the PSE.

FIG. 9 is a diagram of boosting of external input power according to an embodiment of the present disclosure. The external power is input to the booster module, and the booster module boosts the voltage of the external input power, and outputs the boosted power to the proximal end of the PSE. Boosting the voltage of the input power may reduce the loss on the POE transmission path and effectively improve POE transmission efficiency.

From the above, the technical solution of the embodiment of the present disclosure provides a POE-based reliable power supply method, which implements an efficient and reliable POE solution on the basis of ensuring normal transmission of an Ethernet service by PSE proximal-end protection, PSE distal-end protection, PD distal-end protection and PD proximal-end protection. The external power is input to the PSE chip, the PSE chip outputs the power to a network port protection circuit by a normal grading detection process, and protection over the key pins of the PSE chip is configured to ensure that the key pins of the PSE chip is in the normal working state and free of influence of the power sudden change of the power loop. The power input to a PSE distal-end protection circuit is output to a central tap of the network port transformer through the PSE network port protection circuit to be continuously supplied to the PD through the network cable. PSE distal-end protection is configured to suppress the power sudden change introduced from a network cable and a network port and ensure that the sudden change of the loop is reduced into the range bearable for the proximal end of the PSE. The power from a network cable and a network port is input to the distal end of the PD, and is input to the PD chip through a PD proximal-end protection circuit, and the PD chip provides the input power for the load.

POE performance of the embodiment of the present disclosure is verified to meet reliability indexes of the International Electrotechnical Commission (IEC) and the International Special Committee on Radio Interference (CISPR). The reliability indexes of the IEC may include: electrostatic immunity test contact ±6 kV, air ±8 kV and CLASS B (IEC61000-4-2); radiated immunity test 80-2,700 MHz, 80% AM and 10 V/m Class B(IEC61000-4-3); conducted immunity test 150 k-80 MHz, 80% AM, 3 V and Class B(IEC61000-4-6); burst immunity test ±2 KV, 5 Hz and Class B(IEC61000-4-4); surge immunity test 10/700 us, line-to-ground ±6 kV/40Ω and Class B(IEC61000-4-5); and impact current test 2 KA, 8/20 us and Class B(IEC61312-3). The reliability indexes of the CISPR include: conducted disturbance test CLASS B (CISPR 22); and radiated disturbance test CLASS B (CISPR 22).

It is important to note that: 1, the technical solution of the embodiment of the present disclosure includes all cables supporting a POE function and there are no limits to cable types; 2, the technical solution of the embodiment of the present disclosure includes protection over the key pins of the PSE chip, protection over the key pins of the PD chip, PSE output network port protection and PD input network port protection, and is not limited application scenarios where the protection solution is clipped and only one or more protections are selected; 3, the technical solution of the embodiment of the present disclosure meets the reliability indexes of the IEC and the CISPR, and is not limited to application scenarios where a part of the indexes mentioned in the present disclosure or test indexes of the same level or below are met; and 4, the technical solution of the embodiment of the present disclosure includes use of the network port transformers, and is not limited to application scenarios the POE function is realized in other manners instead of the network port transformers.

Method Embodiment

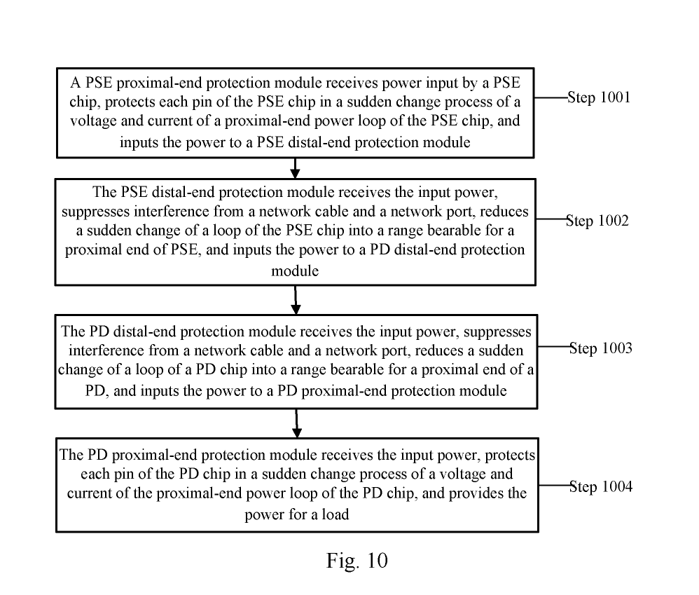

According to the embodiment of the present disclosure, a power supply protection method for POE is provided based on the power supply protection system for POE in the system embodiment, FIG. 10 is a flowchart of a power supply protection method for POE according to an embodiment of the present disclosure, and as shown in FIG. 10, the power supply protection method for POE according to the embodiment of the present disclosure includes the following processing.

Step 1001: a PSE proximal-end protection module 10 receives power input by a PSE chip, protects each pin of the PSE chip in a sudden change process of a voltage and current of a proximal-end power loop of the PSE chip, and inputs the power to a PSE distal-end protection module 12.

In the embodiment, the step that the PSE proximal-end protection module 10 protects each pin of the PSE chip in the sudden change process of the voltage and current of the proximal-end power loop of the PSE chip includes that:

the external input power is clamped through an external voltage clamping module;

a voltage fluctuation from the network port is clamped through a network port voltage clamping module;

a surge current peak is absorbed through a peak current absorption module;

a current fluctuation opposite to a POE current direction is suppressed through a reverse current suppression module; and

port impact current is discharged through a short-circuit protection discharge module in a POE short-circuit protection process.

Step 1002: the PSE distal-end protection module 12 receives the input power, suppresses interference from a network cable and a network port, reduces a sudden change of a loop of the PSE chip into a range bearable for a proximal end of PSE, and inputs the power to a PD distal-end protection module 14.

The step that the PSE distal-end protection module 12 suppresses the interference from a network cable and a network port and reduces the sudden change of a loop of the PSE chip into the range bearable for the proximal end of the PSE includes that:

surge energy from the network port is discharged through a first common mode and differential mode discharge module;

a common mode current sudden change of a positive electrode and negative electrode of a power line is suppressed through a symmetric current sudden change suppression module;

a proximal-end voltage of the PSE chip is clamped into a specific range through a common mode and differential mode voltage clamping module;

surge current is enabled to flow back through a shortest path through a protection ground-to-line low-impedance discharge module in case of line-to-ground surging; and

a current sudden change of a negative electrode of a power supply at the proximal end of the PSE chip is suppressed through an asymmetric current sudden change suppression module.

Step 1003: the PD distal-end protection module 14 receives the input power, suppresses interference from a network cable and a network port, reduces a sudden change of a loop of a PD chip into a range bearable for a proximal end of a PD, and inputs the power to a PD proximal-end protection module 16.

The step that the PD distal-end protection module 14 suppresses the interference from a network cable and a network port and reduces the sudden change of the loop of the PD chip into the range bearable for the proximal end of the PD includes that:

a large amount of surge energy from the network port is discharged through a second common mode and differential mode discharge module;

current opposite to the POE current direction is suppressed through a reverse current suppression module; and

a current sudden change on a PD current side is suppressed through a current sudden change suppression module.

Step 1004: the PD proximal-end protection module 16 receives the input power, protects each pin of the PD chip in a sudden change process of a voltage and current of the proximal-end power loop of the PD chip, and provides the power for a load.

The step that the PD proximal-end protection module 16 protects each pin of the PD chip in the sudden change process of the voltage and current of the proximal-end power loop of the PD chip includes that:

a voltage sudden change of a distal end of the PD chip is clamped through a first voltage clamping module; and

a voltage fluctuation of a load end is clamped through a second voltage clamping module.

Preferably, in the embodiment of the present disclosure, a booster module arranged between the external input power and the proximal end of the PSE chip boosts the external input power, and transmits the boosted power to the PSE chip.

From the above, the technical solution of the embodiment of the present disclosure provides a POE-based reliable power supply method, which implements an efficient and reliable POE solution on the basis of ensuring normal transmission of an Ethernet service by PSE proximal-end protection, PSE distal-end protection, PD distal-end protection and PD proximal-end protection. The external power is input to the PSE chip, the PSE chip outputs the power to a network port protection circuit by a normal grading detection process, and protection over the key pins of the PSE chip is configured to ensure that the key pins of the PSE chip is in the normal working state and free of influence of the power sudden change of the power loop. The power input to a PSE distal-end protection circuit is output to a central tap of the network port transformer through the PSE network port protection circuit to be continuously supplied to the PD through the network cable. PSE distal-end protection is configured to suppress the power sudden change introduced from a network cable and a network port and ensure that the sudden change of the loop is reduced into the range bearable for the proximal end of the PSE. The power from a network cable and a network port is input to the distal end of the PD, and is input to the PD chip through a PD proximal-end protection circuit, and the PD chip provides the input power for the load.

Reliability design modes of the distal ends of the chips and the proximal ends of the chips are protected level by level, so that the problem of low POE transmission reliability in the related art is solved, the sudden change of the voltage and current of the power loops may be effectively suppressed, key pins of the chips may be ensured to meet a chip design requirement, and the chips may be ensured to work in a normal state.

Obviously, those skilled in the art may make various modifications and transformations to the present disclosure without departing from the scope of the present disclosure. Therefore, if these modifications and transformations of the present disclosure fall within the scopes of the claims of the present disclosure and its equivalent technology, the present disclosure is intended to include these modifications and transformations.

### INDUSTRIAL APPLICABILITY

The technical solutions provided by the present disclosure may be applied to a POE protection process, and the reliability design modes of the distal ends of the chips and the proximal ends of the chips are protected level by level, so that the problem of low POE transmission reliability in the related art is solved, the sudden change of the voltage and current of the power loops may be effectively suppressed, key pins of the chips may be ensured to meet a chip design requirement, and the chips may be ensured to work in a normal state.

What is claimed is:

1. A power supply protection system for Power Over Ethernet (POE), comprising at least one of following modules: a Power Supply Equipment (PSE) proximal-end protection module, a PSE distal-end protection module, a Powered Device (PD) distal-end protection module and a PD proximal-end protection module, wherein
the PSE proximal-end protection module is arranged at a proximal end of a PSE chip and configured to protect each pin of the PSE chip in a sudden change process of a voltage and current of a proximal-end power loop of the PSE chip;
the PSE distal-end protection module is arranged between the proximal end of the PSE chip and a PSE network port and configured to suppress interference from a network cable and a network port and reduce a sudden change of a loop of the PSE chip into a range bearable for a proximal end of PSE;
the PD distal-end protection module is arranged between a proximal end of a PD chip and a PD network port and configured to suppress interference from a network cable and a network port and reduce a sudden change of a loop of the PD chip into a range bearable for a proximal end of a PD; and
the PD proximal-end protection module is arranged at the proximal end of the PD chip and configured to protect each pin of the PD chip in a sudden change process of a voltage and current of the proximal-end power loop of the PD chip.

2. The system as claimed in claim 1, wherein the PSE proximal-end protection module comprises: an external voltage clamping module, a network port voltage clamping module, a peak current absorption module, a reverse current suppression module and a short-circuit protection discharge module, wherein
the external voltage clamping module is configured to clamp external input power;
the network port voltage clamping module is configured to clamp a voltage fluctuation from the network port;
the peak current absorption module is configured to absorb a surge current peak;
the reverse current suppression module is configured to suppress a current fluctuation opposite to a POE current direction; and
the short-circuit protection discharge module is configured to discharge port impact current in a POE short-circuit protection process.

3. The system as claimed in claim 1, wherein the PSE distal-end protection module is arranged between the proximal end of the PSE chip and a P SE-end network port transformer, and comprises: a first common mode and differential mode discharge module, a symmetric current sudden change suppression module, a common mode and differential mode voltage clamping module, a protection ground-to-line low-impedance discharge module and an asymmetric current sudden change suppression module, wherein
the first common mode and differential mode discharge module is configured to discharge surge energy from the network port;
the symmetric current sudden change suppression module is configured to suppress a common mode current sudden change of a positive electrode and negative electrode of a power line;
the common mode and differential mode voltage clamping module is configured to clamp a proximal-end voltage of the PSE chip into a specific range;
the protection ground-to-line low-impedance discharge module is configured to enable surge current to flow back through a shortest path in case of line-to-ground surging; and
the asymmetric current sudden change suppression module is configured to suppress a current sudden change of a negative electrode of a power supply at the proximal end of the PSE chip.

4. The system as claimed in claim 1, wherein the PD distal-end protection module is arranged between the proximal end of the PD chip and a PD-end network port transformer, and comprises: a second common mode and differential mode discharge module, a reverse current suppression module and a current sudden change suppression module, wherein
the second common mode and differential mode discharge module is configured to discharge a large amount of surge energy from the network port;
the reverse current suppression module is configured to suppress current opposite to the POE current direction; and
the current sudden change suppression module is configured to suppress a current sudden change on a PD current side.

5. The system as claimed in claim 1, wherein the PD proximal-end protection module comprises: a first voltage clamping module and a second voltage clamping module, wherein
the first voltage clamping module is configured to clamp a voltage sudden change of a distal end of the PD chip; and
the second voltage clamping module is configured to clamp a voltage fluctuation of a load end.

6. The system as claimed in claim 1, further comprising:
a booster module, arranged between the external input power and the proximal end of the PSE chip and configured to boost a voltage of a circuit.

7. A power supply protection method for Power Over Ethernet (POE), comprising at least one of the following steps:
receiving, by a Power Supply Equipment (PSE) proximal-end protection module, power input by a PSE chip, protecting each pin of the PSE chip in a sudden change process of a voltage and current of a proximal-end power loop of the PSE chip, and inputting the power to a PSE distal-end protection module;
receiving, by the PSE distal-end protection module, the input power, suppressing interference from a network cable and a network port, reducing a sudden change of a loop of the PSE chip into a range bearable for a proximal end of PSE, and inputting the power to a Powered Device (PD) distal-end protection module;
receiving, by the PD distal-end protection module, the input power, suppressing interference from a network cable and a network port, reducing a sudden change of a loop of a PD chip into a range bearable for a proximal end of a PD, and inputting the power to a PD proximal-end protection module; and
receiving, by the PD proximal-end protection module, the input power, protecting each pin of the PD chip in a sudden change process of a voltage and current of the proximal-end power loop of the PD chip, and providing the power for a load.

8. The method as claimed in claim 7, wherein protecting, by the PSE proximal-end protection module, each pin of the PSE chip in the sudden change process of the voltage and current of the proximal-end power loop of the PSE chip comprises:
clamping, by an external voltage clamping module, the external input power;
clamping, by a network port voltage clamping module, a voltage fluctuation from the network port;
absorbing, by a peak current absorption module, a surge current peak is absorbed;
suppressing, by a reverse current suppression module, a current fluctuation opposite to a POE current direction; and
discharging, by a short-circuit protection discharge module, port impact current in a POE short-circuit protection process.

9. The method as claimed in claim 7, wherein suppressing, by the PSE distal-end protection module, the interference from a network cable and a network port and reduces the sudden change of a loop of the PSE chip into the range bearable for the proximal end of the PSE comprises:
discharging, by a first common mode and differential mode discharge module, surge energy from the network port;
suppressing, by a symmetric current sudden change suppression module, a common mode current sudden change of a positive electrode and negative electrode of a power line;
clamping, by a symmetric current sudden change suppression module, a proximal-end voltage of the PSE chip into a specific range;
enabling, by a protection ground-to-line low-impedance discharge module, surge current to flow back through a shortest path in case of line-to-ground surging; and
suppressing, by an asymmetric current sudden change suppression module, a current sudden change of a negative electrode of a power supply at the proximal end of the PSE chip.

10. The method as claimed in claim 7, wherein suppressing, by the PD distal-end protection module, the interference from a network cable and a network port and reduces the sudden change of the loop of the PD chip into the range bearable for the proximal end of the PD comprises:
discharging, by a second common mode and differential mode discharge module, a large amount of surge energy from the network port;
suppressing, by a reverse current suppression module, current opposite to the POE current direction; and
suppressing, by a current sudden change suppression module, a current sudden change on a PD current side.

11. The method as claimed in claim 7, wherein protecting, by the PD proximal-end protection module, each pin of the PD chip in the sudden change process of the voltage and current of the proximal-end power loop of the PD chip comprises:
clamping, by a first voltage clamping module, a voltage sudden change of a distal end of the PD chip; and
clamping, by a second voltage clamping module, a voltage fluctuation of a load end.

12. The method as claimed in claim 7, further comprising:
boosting, by a booster module arranged between the external input power and the proximal end of the PSE chip, the external input power, and transmitting the boosted power to the PSE chip.
